(19) United States
(12) Patent Application Publication
(10) Pub. No.: US 2003/0138545 A1
(43) Pub. Date: Jul. 24, 2003

(54) Glucomannan high fiber beverage

(76) Inventor: Guanggu Sun, Chengdu (CN)

Correspondence Address: David T. Bracken, The Law Office of David T. Bracken, 4839 Bond Avenue, Orange, CA, 92869, US

(21) Appl. No.: 10/051,592

(22) Filed: Jan. 22, 2002

(51) Int. Cl. C12C 1/00

(52) U.S. Cl. 426/590

(57) ABSTRACT

The present invention comprises particles of substantial high viscosity soluble fiber treated to be enclosed in a water resistant layer developed by treatment with sodium or calcium salt in the participation of alcohol. In a preferred embodiment, the invention comprises konjac fine powder (particle size of 36˜147 μm) or a mixture of its dissolvable cellulose with edible supplement. The fine konjac powder is treated with sodium or calcium salt in the participation of ethanol which causes a substantial part of the particles to be surrounded in a gel membrane. The edible supplement is at least one of fruit powder, dairy product, plant protein, grain, coffee or solidified carbonic acid beverage. The mixture may contains 10˜60% of cellulose, 40˜90% of edible supplement (in weight). The beverage has many characters, such as good taste, functions of depressing blood fat, reducing blood glucose, curing obesity and astriction, preventing the cancer of lower enteron, building up the immunity of human body and so on. The gel coated fine konjac powder can also be added to flour, meat, or diary food products to produce high fiber food products and improve the taste of those products.

### BACKGROUND OF THE INVENTION

The present invention relates to high cellulosic composition particles prepared for human consumption.

Konjac glucomannan is one of potentially several compositions with desirable cellulosic and/or similar non-digestible polysaccharide, a soluble dietary fiber. Because of its large molecular weight, its resolved viscosity can reach as high as 20,000 cps (Viscosity is tested with an NDJ-1 viscometer, No.4 spindle, 30 rpm, 1% aqueous solution at 25° C.; NDJ-1 is compatible with Brookfield LVT.), 3-10 times of other soluble dietary fiber. According to several clinical studies, konjac glucomannan is useful in regulating lipid metabolism, reducing blood lipid and cholesterol, reducing abnormally high blood glucose, treating constipation, preventing cancer of lower digestive tract, functioning in weight reduction to control obesity and regulating immunologic responses. Glucomannan particles can absorb 100 volumes of water, and remain substantially undigested in the stomach for a long period of time under strong acid condition. Ingestion of konjac laced materials, or konjac material alone causes the user to feel sated, which is helpful in weight control. Ingestion of konjac glucommnan in the form of beverage delivers high viscosity glucommannan to the stomach and intensify the effects of lowering risk of diabetes and coronary heart diseases.

Konjac glucommanan is extracted from the tubers of Konjac (Amorphophallus Konjac) which is a plant cultivated widely in many Asian country including China, Japan and Thailand. In general, the konjac tuber is dried, ground and milled to produce konjac flour. The principal soluble constituent of konjac flour is glucomannan. The konjac jelly dessert produced by konjac flour is a well-known traditional food in Japan and China. But there are two major problems when the natural konjac flour is used as a food additive and source of dietary fiber. First, there are numerous impurities in crude (native, unclarified) konjac flour, principally insoluble starches, cellulose, and nitrogen-containing materials, including proteins. As a result, the sols and gels of crude konjac flour have a highly turbid, milky-white or cloudy appearance (due to water-swollen particulate impurities). Second, the particle size of crude konjac flour is from 175 microns to 350 microns. The solubility of such large particles is so poor that full water absorption into the particles requires up to 30 minutes at 86 degrees F. to make the konjac powder resolve (absorb water to substantially its limit of absorption).

U.S. Pat. No. 4,379,173 describes a process for preparing biscuits containing glucomannan. U.S. Pat. No. 4,844,913 describes a dietary product containing glucomannan powder. Those processes of preparing high fiber foods comprising konjac glucomannan do not require the use of clarified, fine granularity konjac flour or powder since the mass-produced clarified, fine granularity konjac flour or powder was not available at the time of the filing of those patents.

To increase the number of uses of konjac flour, the milled tubers must be clarified and reduced in particle size. U.S. Pat. No. 6,162,906 describes a method for obtaining a clarified konjac glucomannan by washing away the insoluble impurities with one of several alcohols. U.S. Pat. No. 5,536,521 discloses a fine granularity konjac flour which is rapidly hydratable. Those techniques greatly improve the quality of konjac flour.

The prior art fine konjac flour or powders (with particle size less than 147 microns), of which 80%-95% is the active high-viscosity glucomannan, is a very good source of dietary fiber. The solubility of those flour or powders is improved a lot. It only takes 3-5 minutes to be resolved. It is possible to produce the high fiber konjac beverage from those flour or powders. But another problem emerges. The strong viscidity of konjac power causes the beverage to become a paste when konjac power is resolved. Clearly, an unpalatably pasty and viscous material could not be ingested over a long period of time.

In addition to beverage, fine konjac flour can be added to various food products to produce healthy high fiber food products. Because konjac glucomannan has high viscosity, when it reaches certain percentage in the food product, the food product will taste pasty and unpalatable. Long term use is required for high fiber food materials to have their effect. If users cannot not ingest the fine konjac flour products relatively easily and continuously, they cannot obtain its benefit.

Thus, there is a need to get Konjac powder into beverages or other food products without causing the mixture to solidify or become unpalatably viscous.

### SUMMARY OF THE INVENTION

The present invention is a method of treating fine konjac particles so that they may be ingested without unacceptable viscosity or pasty flavor. With immersion or surface treatment by chosen alcohols, fine konjac particles are treated with sodium or calcium salt sufficient to cause an outer layer of glucomannan to become a gel layer substantially coating the particle. Thus is obtained a delayed resolution of the underlying glucomannan in a high moisture (beverage or slurry like material) environment through interposing a gel layer that requires a measurable time, preferably over about 2 minutes, to be dissolved. By the time the gel layer is dissolved, the user will have ingested the particle made into a liquid or slurry and the underlying glucomannan will expand rapidly in the stomach. Substantially no viscosity or pasty flavor is encountered by the user with the gel layer acting as an effective temporary barrier to those unpleasant effects.

It will be clear to those skilled in the art of food preparation that konjac flour or powder according to the present invention may be used in a wide variety of beverages, sauces, instant puddings, soups, or other such food stuffs where dietary fiber could be beneficial to the user. Substantial water should be available from the ingested materials for absorption by the glucomannan in the stomach. Almost every use of flour or cornstarch in such ingestible combinations could be partially or completely replaced with the invention powder or flour.

### DETAILED DESCRIPTION OF THE INVENTION

Generally, the invention comprises a method for making a water absorption resistant (not impervious) powder, the resulting glucomannan powder, products incorporating the invention powder and methods of using the invention powder.

In a first method for forming the invention glucomannan powder, in a first step, one part by weight of fine konjac powder (with particle size preferably less than 147 microns) is stirred into five parts by weight of 30-60% ethanol solution until particles are substantially wetted with the solution. Many ethanol solutions are known to comprise flavorings and may be used in this invention to impart flavoring to the gel layer. In a second step, the wetted particles are undisturbed for about 3-10 minutes. In a third step, one part by weight (compared to the fine konjac powder weight of the first step) of sodium or calcium salt solution (sodium carbonate, sodium bicarbonate, calcium carbonate, etc.) is mixed with the mixture described in step two. In a fourth step, the pH value is adjusted to about 9. In a fifth step, the mixture is stirred for 1-5 minutes, followed by a sixth step of keeping the mixture undisturbed for 10-30 minutes. In a seventh step, the mixture is vacuum filtered through filter media to remove moisture with a vacuum of about a few inches of water. In an eighth step, three parts by weight (as compared to the fine konjac powder weight of the first step) of pure ethanol (more than 95%) are stirred with the filtered solid. In a ninth step, the slurry is filtered once again as in the seventh step. The filtered solid of the ninth step is removed and in a tenth step is dehydrated and dried. The resulting dried particles are the invention powder having particles with a gel coat substantially covering the particles forming a membrane coated fine konjac flour.

It will be understood by the skilled person that the gel layer or membrane is generated by glucomannan itself. With the use of sodium and/or calcium in the third step, the glucomannan will form a gel membrane on a particle that is substantially made of glucomannan. The subsequent pure ethanol washing and filtration of the eighth and ninth steps consolidate the membrane on konjac paticles and prevents the particles form sticking together.

The membrane prevents the fine konjac powder from absorbing water. Normal fine konjac powder can be dissolved in water in about one minute and forms the unpleasant tasting paste. The higher water temperature, the faster releasing of the viscosity. Coating the fine konjac powder with a layer of membrane can delay the viscosity releasing for 5-10 minutes or longer. Though the membrane reduces the releasing speed of the viscosity and pasty flavor, the invention powder with membrane can still reach 80% of its original peak viscosity upon exposure to liquid water while the high viscosity is essential to the health effect of konjac flour. The membrane isn't entirely insoluble. It has been found that fine konjac flour with insoluble membrane is as unpalatable as without a membrane.

It is another embodiment of the invention to use the first method with substantially the same steps on other soluble dietary fiber materials such as carrageenan to produce a similar delayed water absorption and swelling effect in the stomach of the user.

The invention powder makes available for long term use high viscosity soluble fibers, konjac glucomannan, in food products.

### EXAMPLE 1

### Konjac Glucomannan High Fiber Beverage

A konjac beverage with prior art konjac flour can only contain less than 0.5% glucomannan without becoming unacceptably viscous and unpleasant tasting. With so little dietary fiber in a beverage, little benefit is obtained. The inventor has found research indicating that a user ingesting a typical high fat diet for the US will require 10-15 grams of invention konjac flour per day to fulfill the requirement of everyday fiber ingestion. An invention Konjac beverage is made adding 4-6 grams of invention powder to a 10 ounce beverage three times per day. Ingesting the invention powder as a beverage provides enough water (as in fruit juices) for volume expansion of the glucomannan in the user's stomach without concern for sufficiency.

The invention powder can be combined in every type of drinkable and ingestible material, such as fruit powders, dairy products, plant proteins, grains, coffees, cocoas or solidified carbonic acid beverages, and added to water to drink as beverage.

### EXAMPLE 2

### Additive to Flour Food Products

Flour food products like bread, cake, noodle, are staple food of Americans. Increasing the fiber contents in the staple food will increase the fiber intake of the majority Americans, balance their dietary structure. Especially, diabetes patients should control their starch intake strictly. Adding the invention powder into flour food products will increase the fiber contents to more than eight percent, 10 times greater than normal flour food products. Taking this high fiber flour products won't raise the blood glucose level. On the contrary, it will lower the blood glucose level and will be welcomed by diabetes patients.

### EXAMPLE 3

### Additive to Meat Products

Adding invention powder to meat products, like sausages, can not only increase the fiber contents, but also mimic fat-like appearance and taste. We have tried to it in sausages and reduce the fat contents from 20% to 10%. The sausages still taste good. The delay in water absorption permits easy mixing.

### EXAMPLE 4

### Additive to High Fat, High Protein or High Sugar Food Products

Clinical research proves high viscosity soluble fiber can reduce the absorption of fat, protein and sugar in body. Americans eat too much fast food, ice creams and chocolate. Those food products are high calorie food. This is one of the major reasons of the obesity. Adding invention powder to those high calorie foods can reduce the absorption of high calorie contents that are good to health.

A first set of examples of making and use of one form of the invention powder are as follows:

First Set Method.

Add 100 g fine konjac flour(with particles less than 147 microns) into 500 ml 30-60% ethanol solution. Stir fully. Keep undisturbed for 3 minutes. Add 100 ml 12% sodium bicarbonate solution. Adjust the solution pH to 9. Stir 5 minutes. Keep undisturbed 15 minutes. Filtrate. Add 300 ml 95% ethanol solution. Stir fully. Filtrate. Dehydrate to recover the invention powder.

First Set Products.

Product 1. In 4 g of product of the first set method, added 4 g of air-dried pineapple powder and 1 g the mixture of citric acid and sweet flavoring. It could be drunk after dissolved at least 10 ounces of tepid or cool water.

Product 2. 4 g of product of the first set method can be drunk after dissolved in the 10 ounces of milk used over dry cereal.

Product 3. Mixed 300 g flour, 1 g dietary alkali, 4 g salt, 24 g of product of the first set method thoroughly. Add 200 ml water to the mixture. Stir fully. Use noodle machine to cut the mixture into 0.85 mm noodles. Dehydrate with heat to provide high fiber noodle (contains more than 10% fiber by weight)

Product 4. Mix 50 g baking powder and 4 g of product of the first set method. Stir fully. Add 15 g corn oil, 15 g milk, 30 g sugar. Stir fully. Add half an egg, 18 g milk. Stir 5-10 minutes. Bake the mixture at temperature of 350F for 25 minutes to provide the high fiber cake (contains more than 10% fiber by weight).

Product 5. Mix 1.5 g carrageenan, 2.5 g konjac gum, 2 g potassium-citrate thoroughly. Mix 50 g of product of the first set method, 60 g starch, 25 salt thoroughly. Mix those two mixtures together and add the compound to 1000 g ground pork. Stir fully. Add 400 ml water gradually. Stir fully and make it into high fiber meatballs by meatball machine (contains more than 5% fiber by weight).

Steps 1, 2 and 5, 6 of the first method above describe a range of time for contacting the fine powder to be processed. It will be appreciated that increasing the times for steps 1, 2 and 5, 6 above those of the first set method will result in a thicker gel layer or membrane, which in turn may somewhat reduce the amount of glucomannan in the particle available as dietary fiber and for volume expansion when the powder reaches the stomach. However, for products made with the present invention powder where high temperatures (hot foods or beverages) are used with liquids or longer exposure without water absorption into the glucomannan is desired, the invention method can be changed to increase the thickness of the gel layer or membrane in response to those changed conditions.

It is understood that the preferred particle size of 147 microns is determined by standard tests where a measurable and substantial amount of konjac flour to be used as feedstock for the invention powder may have a particle size greater than 147 microns (and a part that is substantially less as well). Thus, although the invention is most preferably practiced with konjac flour in the first step of a particle size of from 34 to 147 microns, it is well known that precision is not practicable with bulk produced materials such as konjac flour and that the invention may be practiced with konjac flour in the range of from about below an average of 160 microns particle size to well below 30 microns particle size.

The above design options will sometimes present the skilled designer with considerable and wide ranges from which to choose appropriate apparatus and method modifications for the above examples. However, the objects of the present invention will still be obtained by that skilled designer applying such design options in an appropriate manner.

I claim:

1. A method for treating glucommannan in a fine konjac powder or flour with an average particle size of less than about 160 microns comprising:
(a) contacting the fine konjac powder or flour with an organic alcohol solution of at least about 30 percent by volume alcohol; and
(b) adding to that mixture a sodium or calcium salt solution such that a gel membrane forms at the surface of the particles by reaction with the glucomannan.

2. The method of claim 1 wherein the mixture of step (b) is filtered to remove liquid from the particles to form a first filtered solids.

3. The method of claim 2 wherein the first filtered solids are contacted with an concentrated organic alcohol solution to consolidate the gel membrane.

4. The method of claim 3 wherein the mixture is filtered to remove liquid from the particles to form a second filtered solids.

5. The method of claim 4 wherein the second filtered solids are dried to form a gel coated powder having substantially all its particles covered in separate gel coats.

6. The method of claim 1 wherein the organic alcohol is an ethanol solution less than or equal to about 60 percent by volume of ethanol.

7. The method of claim 6 wherein the mixture of step (a) is stirred to wet substantially all the fine konjac powder or flour and is maintained thereafter in an undisturbed state for at least three minutes.

8. The method of claim 6 wherein the mixture of step (a) is stirred to wet substantially all the konjac flour and is maintained thereafter in an undisturbed state for less than or equal to ten minutes.

9. The method of claim 6 wherein the mixture of step (b) is stirred and is maintained thereafter in an undisturbed state for at least ten minutes.

10. The method of claim 6 wherein the mixture of step (b) is stirred and is maintained thereafter in an undisturbed state for less than or equal to 30 minutes.

11. The method of claim 5 wherein the gel coated powder contacts a liquid comprising substantial amounts of liquid water.

12. The method of claim 11 wherein the liquid water is prevented from being absorbed by the glucomannan by the gel coats for more than about 2 minutes.

13. The method of claim 12 wherein the liquid water is a beverage or part of a beverage and is ingested by a human user with the gel coat powder before substantial swelling of the glucomannan occurs.

14. The method of claim 12 wherein the liquid water is part of a beverage with a temperature above about 100 degrees F. and is ingested by a human user with the gel coat powder before substantial swelling of the glucomannan occurs.

15. The method of claim 5 wherein the gel coated powder contacts a liquid comprising small amounts of liquid water.

16. The method of claim 15 wherein the liquid water is part of a meat product and is ingested by a human user with the gel coat powder before substantial swelling of the glucomannan occurs.

17. The method of claim 15 wherein the liquid water is part of a dairy product and is ingested by a human user with the gel coat powder before substantial swelling of the glucomannan occurs.

18. The method of claim 15 wherein the liquid water is part of a flour product and is ingested by a human user with the gel coat powder before substantial swelling of the glucomannan occurs.

19. The method of claim 11 wherein the gel coated powder is other high viscosity soluble fiber powder, such as guar gum, alginic gum.
